(19) United States
(12) Patent Application Publication
(10) Pub. No.: US 2018/0004203 A1
(43) Pub. Date: Jan. 4, 2018

(54) Unmanned Aerial Vehicle Weapon System and Method of Operation

(71) Applicant: Artem Ryabov, Colorado Springs, CO (US)

(72) Inventor: Artem Ryabov, Colorado Springs, CO (US)

(21) Appl. No.: 15/530,662

(22) Filed: Jun. 30, 2016

(51) Int. Cl. G05D 1/00; B64D 47/08; F41G 3/06; B64C 39/02; G01S 19/18; F41G 3/22

(52) U.S. Cl. CPC G05D 1/0038; G05D 1/0094; G01S 19/18; F41G 3/22; F41G 3/06; B64C 39/024; B64D 47/08; B64C 2201/12; B64C 2201/021; B64C 2201/146

(57) ABSTRACT

An unmanned aerial vehicle weapon system and method of operation which includes an unmanned aerial vehicle having navigational and weapon aiming cameras, remote controlled flight controls and a rifle type of weapon mounted in the wing transversely to the axis of the fuselage where the aerial vehicle is directed to a general target area and controlled to fly in a circular trajectory above and around a specific target within the target area until acquiring the target with the aiming camera and adjusting the bank angle of the vehicle to direct the weapon to the specific target.

The present invention relates to an armed unmanned aerial vehicle and a method for operating the same in a tactical situation.

### BACKGROUND

Remotely controlled unmanned aerial vehicles, also known as drones that carry bombs or other ordinance to a target are well known. The targets for these drones are traditionally large areas that are thought to contain persons or things of interest. The extent of the damage to the target area is not controlled. Accordingly, the method and apparatus of the prior art has been restricted to battlefield, insurgent and large scale terrorist operations.

It is therefore the primary object of the present invention to provide a small unmanned aerial vehicle and method of operation which improves on existing methods and apparatus in order pinpoint and destroy small specific targets without collateral damage. The present invention can obviously be employed in traditional battlefield scenarios, but finds particular utilization in hostage situations, police and anti-terrorist deployments.

### SUMMARY OF THE INVENTION

A lightweight remotely controlled drone aircraft having a fuselage, conventional wings, an empennage, flight controls and electrically driven propeller is equipped with a wide angle video camera and a narrow field video aiming camera, both with associated laser rangefinders. The drone also includes a computer and a connected transceiver which transmits signals representing the video outputs of the cameras and the information from the rangefinders to a remote control site whose operator receives the video information and remotely controls the track of the drone to a target area. After the remote operator identifies the specific target the drone is directed, either manually by the operator or autonomously with the on-board computer, to maintain the target on sight throughout one or more circular trajectories of the drone above the target.

A light weight weapon that uses low recoil impulse cartridges, such as an AR-15 semi-automatic rifle is mounted within the wing structure of the drone and positioned to fire in a direction perpendicular to the longitudinal axis of the fuselage. The firing mechanism of the weapon in controlled by an output from the computer that receives a firing signal from the remote control operator. As the drone is flying the circular trajectory around the target, the weapon is aimed through the use of the telescopic aiming camera, the aiming rangefinder and by the operator remotely controlling the bank angle of the wing of the drone. When the aiming camera shows the weapon to be properly positioned to strike the target the operator causes the weapon to fire.

### DESCRIPTION OF THE DRAWINGS

FIG. 1 is a bottom view of the unmanned aerial vehicle of the present invention.

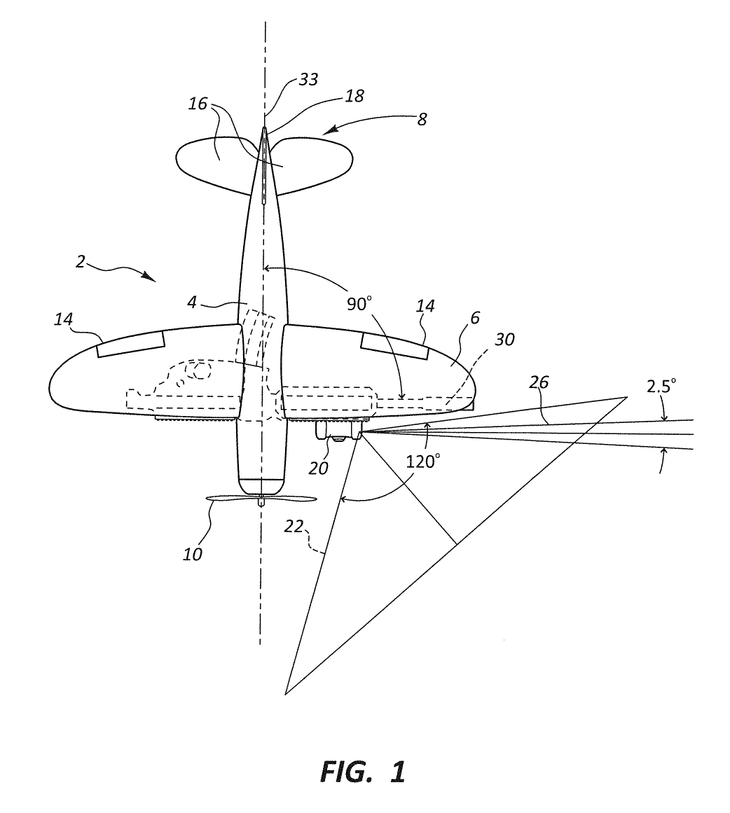

FIG. 2 is a block diagram of the components of the unmanned aerial vehicle weapon system of the present invention.

FIG. 3 is a diagrammatic view of the tangential approach of the drone to a target and the following circular trajectory of the drone around the target.

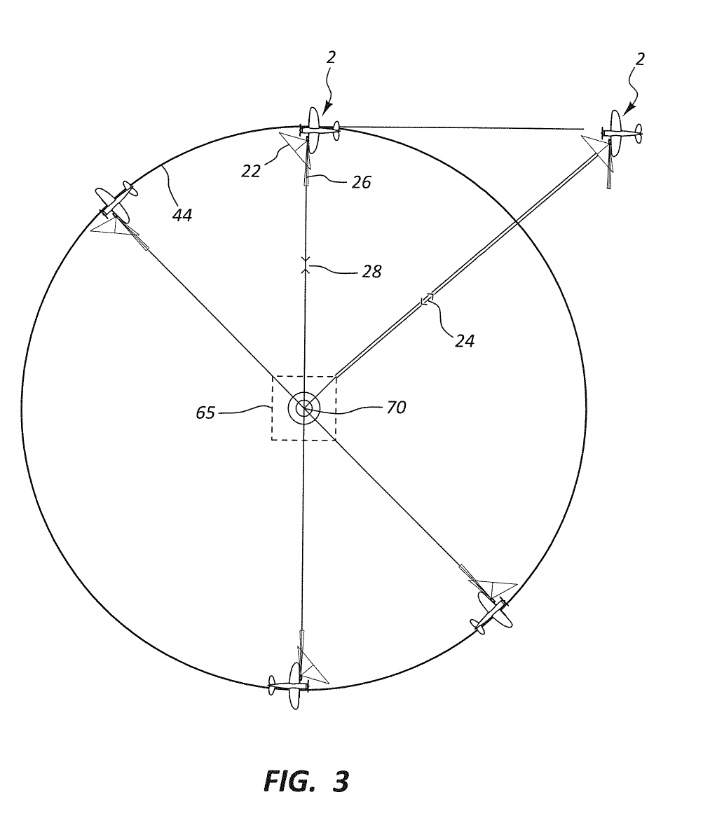

### DETAILED DESCRIPTION OF PREFERRED EMBODIMENT

The drone 2 of the present invention includes a conventional fuselage 4, a wing structure 6, including a lifting airfoil, an empennage 8 and a propeller 10 driven by a battery powered engine (not shown). Conventional flight controls 12 of the drone include wing trailing edge ailerons 14, elevators 16 and rudder 18. A nacelle 20 mounted on the leading edge of one wing carries at least one wide angle (120 degrees) video camera 22 with an associated rangefinder 24. A telescopic video camera 26 with an associated rangefinder 28 is also carried by the nacelle. Mounted within the wing structure 6 is a light weight weapon 30 that uses low recoil impulse cartridges, such as an AR-15 semi-automatic rifle. The weapon is positioned within the wing structure 6 so that its firing line is perpendicular to the longitudinal axis 33 of the drone's fuselage.

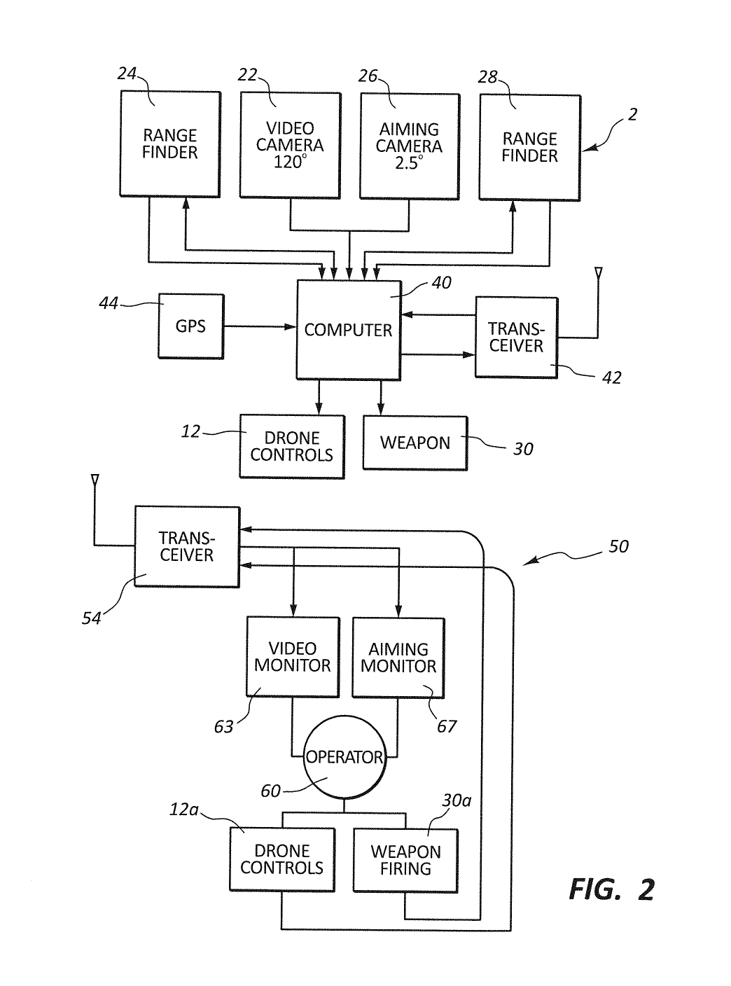

Referring to FIG. 2, the components of the total system are shown in block diagram form. A central processing computer 40 is located within the drone 2 and provides data output to a transceiver 42 which transmits the data from a co-located GPS receiver 44 and the inputs from the video cameras 22 and 26 and the rangefinders 24 and 28 to a remote control station 50. The transceiver 42 receives flight control and weapon firing data from a transceiver 54 in the remote control station and conveys it to the computer 40 which utilizes the data to control the flight of the drone 2 and fire the weapon 30.

In operation, the unmanned aerial vehicle 2 is launched for the purpose of excising one or more specified small targets, such as one or more individuals within a general target area 65, such as a military compound or the scene of a terrorist shooter. The operator 60 at a remote control site 50 flies the drone with local controls 12a and receives navigational assistance from the at least one wide angle video camera 22 carried by the drone, as displayed on a monitor 63, to locate and identify the general target area 65. Using the aiming monitor 67 to visualize the output of the telescopic aiming camera 26, the specific target 70 is identified. The drone is then manually controlled by the operator, or autonomously by the computer 40, to fly in a circular trajectory 80 around and over the target 70. The weapon is aimed at the target by adjusting the remote flight controls 75 to change the bank angle of the drone through the drone flight controls 12 while maintaining a constant angular velocity around the point of the target. Depending on a variety of factors, the operator may choose to immediately activate the weapon firing control 30a upon obtaining target acquisition or the operator may choose to wait for execution of the weapon firing until later in the first circular trajectory or during one or more of the following circular trajectories.

I claim:

1. A method of acquiring and destroying a target comprising the steps of;
remotely control a weapon carrying unmanned aerial vehicle to a target area,
identify a target within the target area,
acquire the distance to the target and compute a circular trajectory of the unmanned aerial vehicle around the target,
execute the computed circular trajectory around the target,
remotely control the unmanned aerial vehicle to aim the weapon at the identified target along a radius of the circular trajectory.

2. The method of claim 1 and further including the step of,
controlling the unmanned aircraft autonomously to maintain the target on sight throughout the circular trajectory.

3. The method of claim 2 and further including the step of,
remotely controlling the firing of the weapon radially of the circular trajectory.

4. An unmanned aerial vehicle weapon system comprising,
an unmanned aerial vehicle including a fuselage having a longitudinal axis, power plant, flight controls and at least one rigid lifting surface structure,
a wide-angle video camera, having a rangefinder, carried by the at least one rigid lifting surface structure,
a telescopic aiming camera, having a rangefinder, carried by the at least one rigid lifting surface structure,
a weapon having a barrel and carried within the at least one rigid lifting surface structure where the barrel is positioned and arranged perpendicularly to the longitudinal axis of the fuselage,
a GPS receiver,
a computer programed to fly the unmanned aerial vehicle in a circular trajectory around a target point and carried by the unmanned aerial vehicle and having inputs from the GPS receiver, the rangefinders and the outputs of the video wide-angle and aiming cameras,
a digital data transceiver connected to the computer,
means for operating the flight controls from a remote location, and
means for firing the weapon from a remote location.

5. The unmanned aerial vehicle weapon system of claim 4 and further including,
a remote control station including,
a receiver for receiving the signals transmitted from the transceiver, including signals representative of the video outputs of the wide-angle and aiming cameras,
monitors for displaying the video outputs of the wide-angle and aiming cameras,
remote flight controls for the unmanned aerial vehicle,
a weapon firing control,
a transmitter, including inputs from the remote flight controls and the weapon firing control and arranged to transmit a signal modulated with the flight control and weapon firing information to the transceiver.

6. The unmanned aerial vehicle weapon system of claim 5 and further including,
Means for controlling the unmanned aircraft autonomously to maintain the target on sight throughout the circular trajectory.
